(19) United States
(12) Patent Application Publication
(10) Pub. No.: US 2024/0403549 A1
(43) Pub. Date: Dec. 5, 2024

(54) SYSTEM AND METHOD FOR PROCESS-BASED PLAGIARISM AND AUTHORSHIP DETECTION

(71) Applicant: Antecedent Writing Analytics, Calgary (CA)

(72) Inventors: Raymond OENBRING, Calgary (CA); Yashar GHAEMI, Thunder Bay (CA)

(73) Assignee: Antecedent Writing Analytics, Calgary, AB (CA)

(21) Appl. No.: 18/607,334

(22) Filed: Mar. 15, 2024

(30) Foreign Application Priority Data
Mar. 29, 2023 (CA) 3194524

(51) Int. Cl. G06F 40/194; G06F 16/14

(52) U.S. Cl. CPC G06F 40/194; G06F 16/152

(57) ABSTRACT

A system and method for evaluating the effort and process involved in drafting written works within a comprehensive writing analytics system. The system emphasizes the importance of the writing process over the final product. By capturing and analyzing time-coded text snapshots during authoring sessions, the system generates objective measures of student writing effort and revision history. The evaluation software component integrates seamlessly with existing word processing platforms, offering real-time visualization of writing analytics through intuitive graphical representations such as composition graphs.

### FIELD OF INVENTION

The present invention generally relates to a computer-based system and method for effort measurement and evaluation in documents created in a web browser or client word processing application served from a server.

### BACKGROUND OF INVENTION

Presently, many methods for assessing the integrity and quality of such works rely on text-based interfaces that, while effective in detecting similarities and instances of plagiarism, do not provide insights into the effort expended by authors during the writing process. This gap in the current evaluation methodology has been exacerbated by the rise of advanced digital technologies, including artificial intelligence (AI) and automated writing assistance tools. While beneficial in aiding the writing process, these technologies introduce complexities in distinguishing between the genuine effort of authors and the contributions of automated systems. The challenge is not only in identifying the originality of the content but also in appreciating the nuanced process of revision, editing, and creative thought that defines quality academic and professional writing.

Though widely used, traditional plagiarism detection services and text-based review systems are limited in capturing the dynamic writing process. They are designed to compare textual content against databases of existing works but cannot analyze the evolution of a text from its initial draft to its final form. This limitation highlights a significant opportunity for innovation in evaluating written works, emphasizing the need for a solution that can provide a more holistic view of the writing process.

The present invention addresses these issues by introducing a novel approach to evaluating written works, focusing on visualizing the effort and process rather than solely on the textual content. While conceived to offer commercially beneficial solutions, this approach aims to leverage graphical interfaces to represent the evolution of written documents in a manner that is both intuitive and informative. By mapping out the various stages of writing, including revisions, edits, and the overall progression of the text, this system offers a unique insight into the effort behind the work.

Introducing a graphical composition dashboard represents a significant departure from traditional text-based evaluations, providing a visual representation of the authoring activities that contribute to developing a written work. This visualization enhances the evaluator's understanding of the author's effort and introduces a more engaging and interactive element to the review process.

### SUMMARY OF INVENTION

The present invention is a system and method for evaluating expended effort and revision in written works. By highlighting the limitations of current text-based methodologies and introducing a novel graphical approach, the present invention positions itself as a pioneering solution that addresses the need for a more comprehensive and nuanced evaluation of the writing process. This approach aligns with the evolving demands of writing assessment and offers a path forward in appreciating the actual value and effort behind academic and professional documents.

This innovation leverages a comprehensive digital framework designed to offer a detailed insight into the authoring and editing processes, enabling evaluators to ascertain the effort. It changes a written work has undergone over time. This system finds application in various domains, including, but not limited to, academic evaluations, peer reviews, editorial processes, and collaborative writing projects.

The invention comprises a server equipped with a processor, memory, and at least one network interface for communication with client devices belonging to authors and evaluators. This server is the central node of the invention, facilitating all interactions and data transactions within the system.

A work database, housed within the server, contains work records for each piece of writing. These records detail the authentication particulars of each author and assigned evaluator, and for each authoring session, a series of periodically captured, time-coded text snapshots of the work delineate the authoring timeline.

An activity database is also part of the server's architecture, holding activity records corresponding to various authoring activities detectable within the work. These records contain detection parameters for identifying occurrences of said activities between time-adjacent text snapshots and interface rendering information for a composition dashboard.

An evaluation software component, operating in conjunction or integration with word-processing software, facilitates the execution of the method steps outlined.

The method commences with an authoring request from an author device, leading to the initiation of an authoring session. This involves authenticating the author device, creating or accessing a work record, serving an authoring interface, and periodically capturing and storing time-coded text snapshots.

Evaluation sessions begin upon an evaluator device's request, involving authentication, comparison of text snapshots to detect authoring activities, and generating and serving a graphical composition dashboard interface. This interface displays a selected text snapshot alongside a two-axis composition graph illustrating the authoring timeline and word length, as well as detected authoring activities as plot points.

The invention allows for selecting particular time points or versions of the work for focused evaluation, with activities encompassing text insertions, deletions, edits, and the timing thereof. Activity records may also include scoring data for evaluation purposes.

The described system and method enable the execution of all claim elements, providing a novel approach to evaluating written works' development and refinement. The invention's utility spans from the detailed monitoring of the authoring process to the nuanced evaluation of revisions, offering a significant tool for authors and evaluators.

This invention seamlessly inserts itself into users' workflows, enhancing the evaluation process without disrupting established writing habits by integrating with existing word-processing platforms as a hosted solution or through a computer network connection.

The present invention's evaluation software component is designed with flexibility and adaptability at its core, enabling its integration and deployment in multiple configurations to meet the diverse needs of educational institutions and users. One embodiment of the evaluation software is its integration into a bespoke word processor offered directly through the server. In this configuration, the server hosts a comprehensive word processing platform that includes all the functionalities of traditional word processors, enhanced with the evaluation software's unique features for monitoring, analyzing, and evaluating the writing process. This integrated approach ensures that users have access to a unified, cohesive environment for drafting and editing written works, with the added benefits of real-time writing analytics and feedback.

Alternatively, the evaluation software can be deployed as a plugin or add-on component that operates in conjunction with existing third-party word processing platforms. This flexibility allows the system to be integrated into widely used word processors, extending the reach of the evaluation software's capabilities to a broader user base without requiring them to transition away from their preferred writing tools. The plugin communicates with the server to access the evaluation software's functionalities, enabling the capture of time-coded text snapshots, analysis of writing effort and revision history, and generation of analytical visualizations, all within the familiar interface of the third-party word processor.

In conclusion, this invention offers a sophisticated framework for tracking, analyzing, and evaluating the evolution of written works, bringing transparency and insight to the evaluation process that was previously unattainable. Thank you for the opportunity to assist in protecting this innovative method and system.

### BRIEF DESCRIPTION OF DRAWINGS

A preferred embodiment of the present invention is described below concerning the accompanying drawings, in which:

FIG. 1 is a block diagram showing the components of one embodiment of a system by the present invention;

FIG. 2 is a block diagram showing the components of the server of FIG. 1;

FIG. 3 is a schematic diagram showing a sample embodiment of a data structure of the work database of FIG. 1;

FIG. 4 is a schematic diagram showing a sample embodiment of a data structure of the activity database of FIG. 1;

FIG. 5 is a flowchart demonstrating the steps in one embodiment of a method by the present invention;

FIG. 6 is a flowchart demonstrating the steps of one embodiment of an authoring session subroutine by FIG. 5;

FIG. 7 is a flowchart demonstrating the steps of one embodiment of an evaluation session subroutine by FIG. 5;

FIG. 8 is a sample of a composition graph by the invention;

FIG. 9 is a sample screenshot of an authoring interface by the invention;

FIG. 10 is a sample screenshot of an evaluator interface by the invention and

FIGS. 11A through 11D are smaller samples of composition graphs by the invention, demonstrating sample views of different qualities of written work assessed by the method.

### DETAILED DESCRIPTION OF ILLUSTRATED EMBODIMENTS

Unless defined otherwise, all technical and scientific terms used herein have the same meaning as commonly understood by one of ordinary skill in the art to which the invention belongs. Although any methods and materials similar or equivalent to those described herein can be used in the practice or testing of the present invention, the preferred methods and materials are now described.

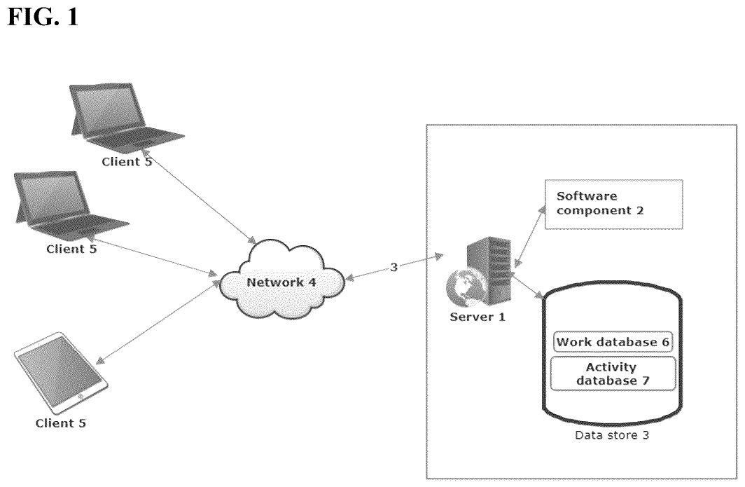

Referring first to FIG. 1, the present invention shows a system diagram of one embodiment of a system. Server 1 hosts an evaluation software component 2. Also shown is a data store 3 in server 1, where various user credentials, settings, software instructions or other data could be stored or archived. Server 1 also includes a network interface 4, operatively connected to network 4 by which server 1 can communicate with client devices 5. Within data store 3, a working database 6 and an activity database 7 are shown.

Client devices 5, as shown in this figure, are a plurality of hardware devices capable of facilitating user participation in an audio or video conference in a selected participation language. Computers and smart devices are both shown. As outlined throughout, it will be understood that the client devices 5 could be any hardware and software combination capable of facilitating the method of the present invention in terms of either facilitating the conduct of an authoring session or an evaluation session therefrom.

### Authoring Activity Types

The concept of authoring activities plays a pivotal role in the evaluation methodology outlined. It is grounded in the idea that a detailed analysis of the actions taken during the creation and revision of written works can provide significant insights into the effort and thought process of the author. These activities, captured as a series of discrete actions within the writing process, form the basis of an ‘activity fingerprint’ that characterizes each document's unique developmental journey.

Authoring activities refer to any action an author takes that contributes to the creation, modification, or refinement of a written work. These activities are associated with a work record as part of the system's effort to monitor and evaluate the writing process, offering a granular view of how a document evolves. This approach allows for a comprehensive assessment of the author's engagement with the work, moving beyond the final product to understand the depth and breadth of effort in crafting the text.

It is intended that a variety of authoring activities can or should be detected and measured. These activities encompass a wide range of actions an author might undertake during the writing process, providing a multifaceted picture of document development. The specific types of authoring activities mentioned include:
1. Text additions—evaluate the size (volume) of text insertions and the time involved in adding these portions to understand the pace and scale of content generation.
2. Text deletions—by tracking deletions, the system gains insights into the editing process, including the scale of content that is reconsidered or refined.
3. Text modifications can include punctuation changes, replacement of words, addition of spaces, adding direct quotes or in-text citations, etc.
4. Editing time—the length of time associated with creating particular blocks of text within the work can help evaluators understand the pacing of the writing process and identify sections that may have required more thoughtful consideration or research.
5. Introduction of specific grammatical structures in the text. This can indicate a higher level of linguistic complexity and thoughtfulness in the work's composition.

The system offers a nuanced and detailed view of the writing process by capturing and analyzing these various authoring activities. This methodology enables evaluators to assess not only the quality and originality of the final work but also the diligence, creativity, and effort expended by the author throughout the creation and revision stages.

Each type of edit provides insight into the level of detail and precision with which an author is refining their work. There are many other types of authoring activities which may provide additional information or data points for your generation of a fulsome composition dashboard concerning a work, and it will be understood that any authoring activity for which a set of detection instructions could be created and stored in a related activity record by the remainder of the invention would be intended to be encompassed within the scope of the present invention.

### System Overview

According to certain embodiments of the present invention referred to in FIGS. 1 to 3, a system for use is disclosed in the facilitation of evaluation of expended effort and revision in written works. The system, as outlined comprises server 1 with a processor 8 and memory 9, the memory 9 containing an evaluation software component 2 executable by the processor 8 and other related components of server 1 as well as a work database 6 and an activity database 7 which will be used to facilitate the method. The present invention's system and software can be used to communicate with client devices in authoring and evaluation sessions. The software and process can be facilitated either directly through the user interface served from server 1 or by a software component 2, which will be installable as a plug-in or the like in a pre-existing or third-party word processing or text editing component in another cloud-based server. It is specifically contemplated that the system of the present invention would be offered in a client/server environment, potentially one with the use of a wide area network such as a cloud-based network or wide-area network, or could also be used in a local area network such as within an educational institution and the like. Both such approaches are contemplated within the scope of the present invention. The system is accessible to authors and evaluators through a web browser or web-based application. It allows authors to write and edit a document/work in a web browser or web-based application for subsequent evaluation by the evaluator. The number of authors and evaluators accessing the system is unlimited in a client/server embodiment.

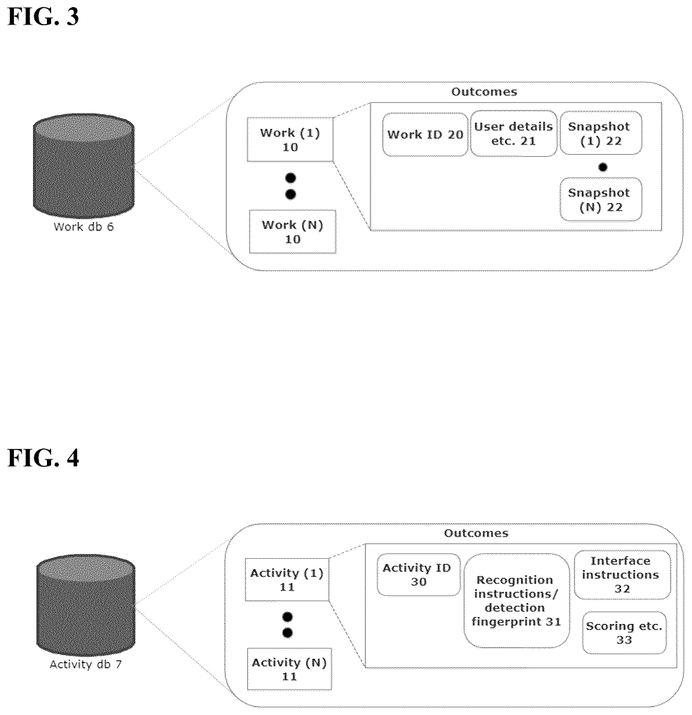

FIGS. 3 and 4 show sample embodiments of data structures which might be used for the work database 6 and the activity database 7. The essentiality and functionality of databases 6 and 7 are discussed further below.

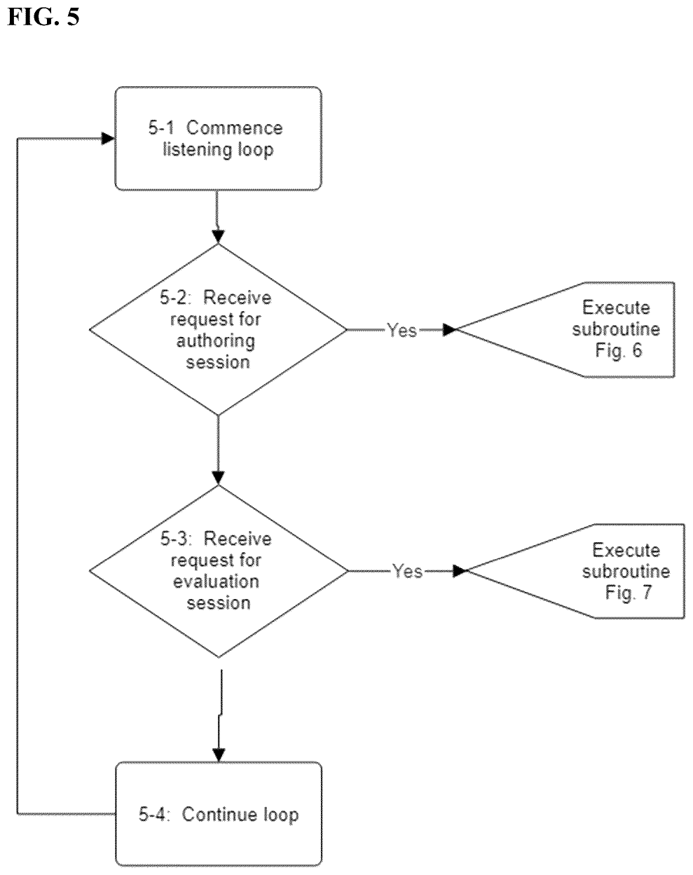

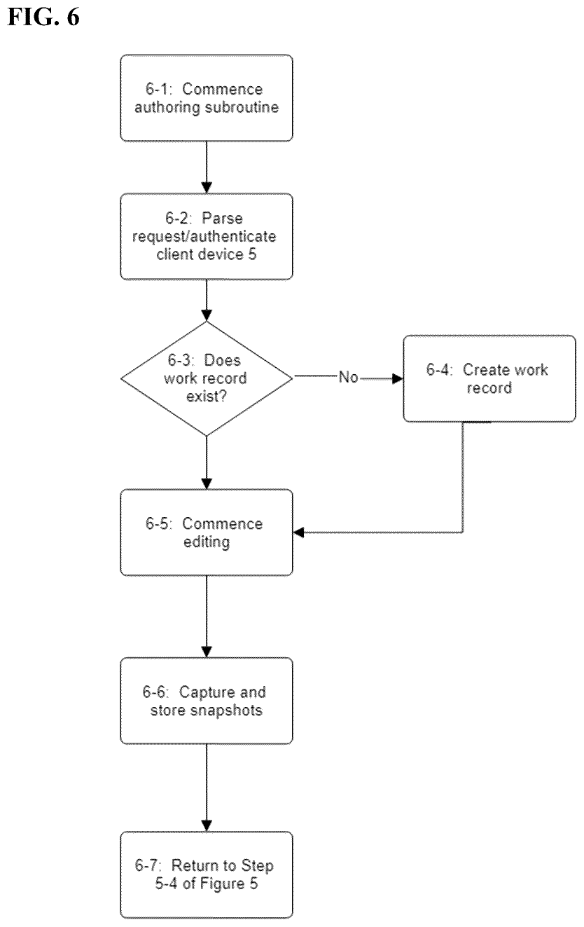

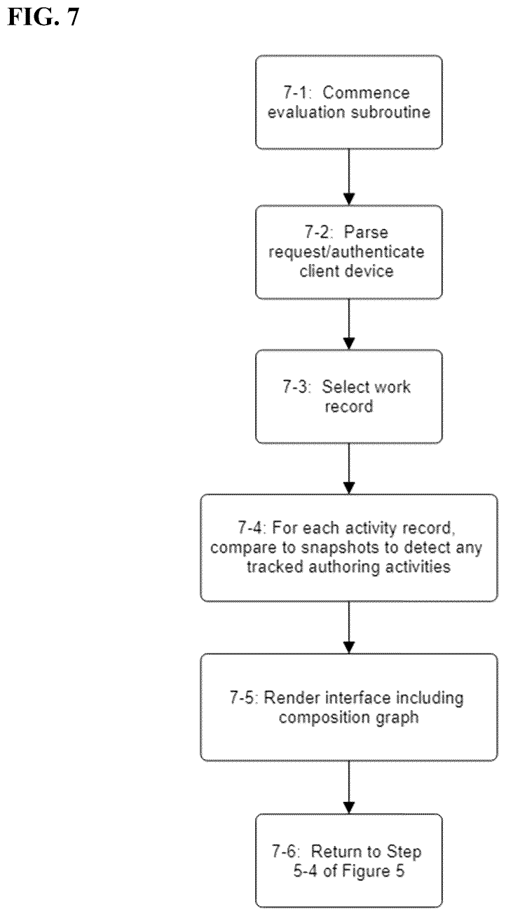

Referring to FIG. 5, there is shown a flowchart of the steps of the first embodiment of the method of the present invention, describing the method of the invention from a high level. The method, generally speaking, comprises receiving requests at server 1 from client devices 5 for the commencement of facilitation of authoring sessions or evaluation sessions concerning particular works represented in the work database 6. Where a request for an authoring session or an evaluation session is received at the server, the method of FIG. 5 has subroutines shown in FIG. 6 and FIG. 7, which are detailed further below and describe the technique of each of those types of sessions within the scope of the invention. The general method shown in this Figure is a listening loop on the network interface 4 of the server 1. The specific architecture and structure of the hardware and software of server 1 and related other software components will be understood by those skilled in the art to be variable in nature, and any such approach is contemplated within the scope of the present invention.

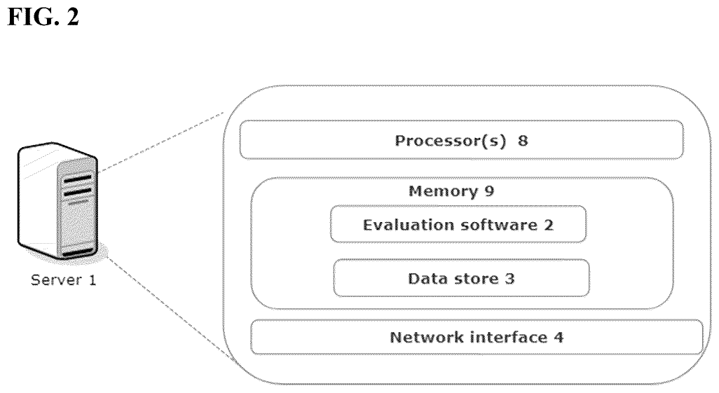

A server 1, as shown in FIGS. 1 and 2, comprising a processor, memory and at least one network interface 4, and hosting evaluation software can be used to facilitate the method.

Regarding a particular authoring or evaluation session, server 1 would reduce the session using its software components capable of the necessary data capture and rendering functions outlined herein.

### Work Database

FIG. 3 is a schematic drawing of a sample data structure of an embodiment of a work database 6. Per the present invention, the work database 6 comprises a plurality of work records 10. As outlined above and will be understood to those skilled in the art, the various data structures and formats of a dataset representing the necessary written work information to comprise the plurality of work records 10 will be all understood to be within the scope of the present invention and understood to those skilled in the art in this Figure, the plurality of work records 10 are shown each of which is demonstrated to comprise several relational keys or other information required in the typical relational database format to facilitate data transactions such as those needed for the method of the present invention. A work ID 20 is shown, which would effectively be a serial identifier for record 10. Most data structures include a unique record identifier 20 for each record in the table or some data formats. Another field of the records used as identifier 20 in both approaches is contemplated herein.

In the embodiment of the work database 6 shown in this Figure, the data structures intended to demonstrate the ability of the method of the present invention in an embodiment of the method used to administer the evaluation method in respect of multiple written works. In addition to the work ID 20, user authentication information or other data could be stored in record 10, shown at 21, as well as the periodically captured time-coded text snapshots of the work referenced in the remainder of the method will be captured and stored in association with the record 10, shown at 22. The time-coded text snapshots 22 might be stored directly in our associated table of the work database 6 related to the work records 10 or stored in another linked dataset. Again, both such approaches are within the scope of the present invention.

It will be understood that other fields could be included in a record or a database of this type to enrich the user interface or add functionality to the method. The addition of such added data tracking with respect to particular works or editing activities to enhance the administration of the method of the present invention are all contemplated within the scope hereof.

### Activity Database

FIG. 4 is a schematic drawing of a sample data structure of an embodiment of an activity database 7 by the present invention. The activity database 7 is comprised of a plurality of activity records 11. As outlined above, it will be understood to those skilled in the art that various data structures and formats of the dataset representing activity detection and interface representation as outlined throughout will all be within the scope of the present invention as claimed.

Each of the activity records 11, as shown, included activity record identifier 30, which is potentially simply a record identifier for database matching purposes, along with a field or data structure facilitating the storage of processor recognition instructions or a detection fingerprint 31 for the particular type of activity which it is desired to detect in terms of the editing of work in an authoring session. The recognition instructions or detection fingerprint 31 will be the information required to detect a particular type of document between time-adjacent groupings of time-coded text snapshots 22 as stored in the work database 6. A specific activity detection fingerprint 31 may be structured in a way to permit a very granular character level at it, which might take place between adjacent snapshots 22, or it may be configured to allow the detection of a particular type of grammatical structure or edit which might take shape in the work subject of the corresponding work record 10 in multiple time adjacent snapshots 22. Both such approaches are contemplated within the scope of the present invention.

In addition to the recognition instructions or detection fingerprint 31, each activity record 11 would also include necessary interface instructions 32 which would be information to permit the rendering of the composition dashboard in an evaluation session and the composition graph to show a particular type of edit taking place in a specific spot in the editing timeline of the work defined by the stored snapshots 22. The interface indicator of a particular type of edit could be anything from a simple graph plot point in a particular colour or shape to a more detailed interface indication to show a specific kind of effort or editing. Any interface indicator will be understood to be within the scope of the present invention, and the necessary interface instructions 32 to achieve the same are all contemplated within the scope of the present invention. Additionally, in embodiments of the method of the present invention, the system in an evaluation session will effectively provide an effort or composition score about the work being reviewed; there may be particular positive or negative scoring attributes associated with specific types of edits in the document, and the necessary instructions to render an aggregated score for the ultimate work incorporating scoring of individual edits and activities could be stored as well and is shown in 33. It will be understood that other fields could be included in a record or a database of this type to enrich the user interface or add functionality to the method. The addition of such added data tracking concerning particular works or editing activities to enhance the administration of the method of the present invention is all contemplated within the scope hereof.

### Client Devices

The method of the present invention explicitly contemplates the use of network-enabled mobile client devices 5 to initiate authoring or evaluation sessions by the remainder of the technique. FIG. 1 shows a sample of these devices 5, including tablets or a larger format screen or computer. It will be understood by those skilled in the art of system design of this nature that any device which would communicate with server 1 via a network interface and the related network interface components would be understood to be within the scope of the present invention. The client devices 5 would, in most likelihood, include pre-existing software such as a browser, for example, which could be used to facilitate the method of the present invention, either by accessing text editing software hosted by server 1 of the present invention, which incorporated the methodology of the present, or could alternatively also be used to edit a document in another third-party hosted pending solution through a browser interface which was integrated with the server 1 to capture the necessary snapshots and creation and administer record in the present method, both of which approaches are again explicitly intended to be within the scope of the present invention. Freestanding and purpose-built client software on the client device 5 could also be used to deliver the method of the present invention, which will also be understood to be encompassed herein. However, it is explicitly contemplated that the delivery of the method of the present invention through a browser-based plug-in or word-processing integration is the most likely delivery channel for the system and method outlined herein.

### Method Overview

As illustrated in the flowchart depicted in FIG. 5, the method commences with server 1 initiating a listening loop 5-1 via its network interface 4, awaiting requests from client devices 5 for either authoring or evaluation sessions related to works cataloged within the work database 6. Upon receipt of such a request, shown at 5-2 and 5-3, the method will execute the associated subroutine for either an authoring session (FIG. 6) or an evaluation session (FIG. 7)—the loop is also shown to continue. The method and the loop of FIG. 5 are then shown to continue. It will be understood that there may be other high-level approaches to the methodology of the invention, including the triggering of authoring and evaluation sessions that may or may not include a listener or any loop, as is shown in this Figure. Any alternate embodiments are also intended to be within the scope of the present invention.

Within the authoring subroutine, as outlined in FIG. 6, when triggered based on a request for an authoring session from a client device, the procedure initiates with the authentication of the requesting author device with the server 6-2, subsequently leading to the creation or access of a selected work record 6-4 within the work database 6. This sequence progresses with the serving of an authoring interface to the author device 6-5, enabling the commencement of the authoring activity. Throughout the session, the system periodically captures time-coded text snapshots of work 6-6, storing these snapshots 22 in association with the corresponding work record 10, thereby creating a detailed chronological record of the authoring process. When the editing session is completed, control of the routine with respect to this particular session will return to the primary loop of FIG. 5.

The system is equipped to handle requests for authoring sessions, including scenarios where the work in question is not yet represented within the work database. This capability is crucial for ensuring that the system remains versatile and responsive to the needs of its users, accommodating both ongoing and new writing projects. Following the creation of the new work record, the system continues with the authoring session, serving an authoring interface to the author's device 6-5 and commencing the periodic capture of time-coded text snapshots 6-6.

By ensuring that each work—new or ongoing—is accorded a unique record within the work database 6, the system lays a solid foundation for a comprehensive analysis of authoring activities with deeper insights into the effort and revisions characteristic of creating written works.

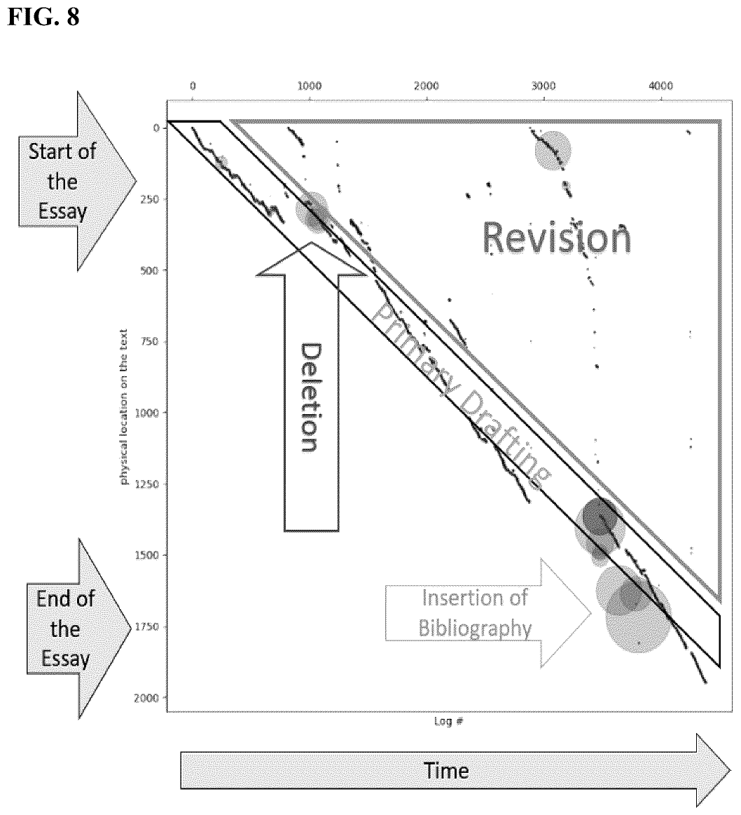

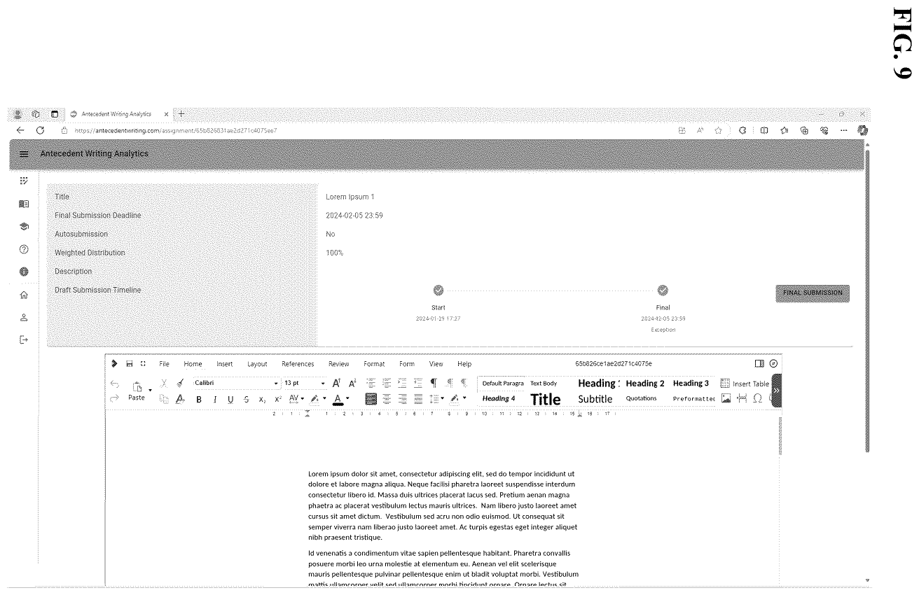

For evaluation sessions, as detailed in FIG. 7, the procedure similarly initiates with the authentication of the evaluator device and selection of an associated work record 7-3, followed by the comparison of time-adjacent pairs of text snapshots stored within the work database 6 to each activity record 11 in the activity database 7. This comparison, shown at 7-4, leverages detection parameters housed within the activity database 7 to identify occurrences of specific authoring activities, generating a dataset of time-coded authoring activities. The culmination of this process is generating and serving an evaluation interface, which includes a graphical composition dashboard, to a display interface of the evaluator device, which consists of a composition graph depicting these detected activities along the authoring timeline. FIG. 8 is a sample of a composition graph which can be used to understand the general nature of the contemplated interface.

The detection of specific authoring activities (e.g., text insertions, deletions, and edits) is achieved through the analysis of changes between successive text snapshots 22 or groupings of text snapshots, with each detected activity corresponding to a distinct data point on the composition graph. These data points, derived from activity records 11 within the activity database 7, are visually represented on the graph through interface instructions 32, providing a graphical illustration of the authoring process that spans from the work's inception to its final form. This visualization not only facilitates a nuanced evaluation of the effort expended in creating and revising the work but also enables a more interactive and engaging review process.

The present invention offers a structured approach to evaluating written works, through the execution of specified steps within authoring and evaluation sessions. The system provides a detailed assessment of authoring activities, encapsulating the effort and revisions underlying the creation of written works. This approach, emphasizing graphical representation and interaction, is a significant advancement in the field of written work evaluation, offering a deeper, more accessible insight into the authoring and revision process.

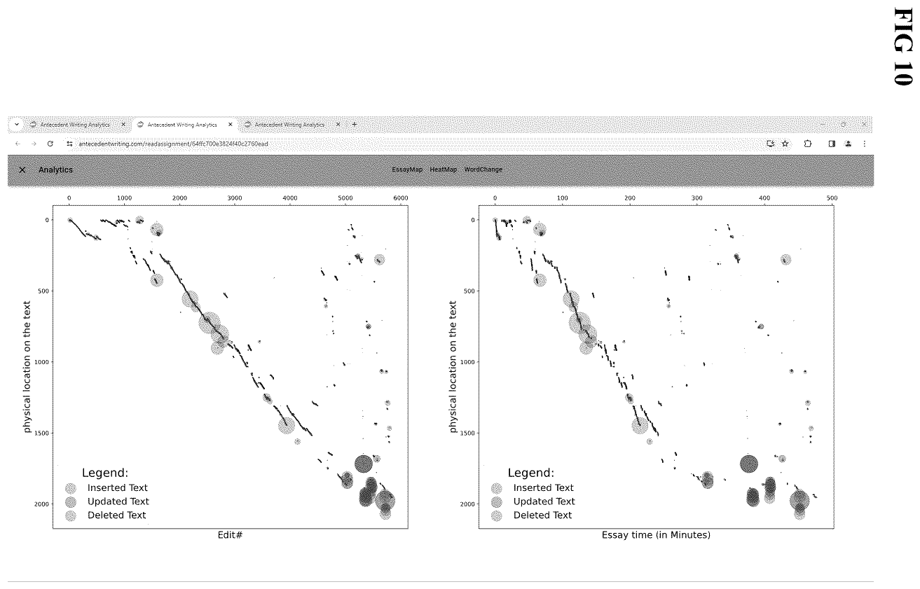

FIGS. 9 and 10 are provided as sample screenshots of one example of each of an authoring session user interface and then an evaluation session user interface, which might be served to the relevant client device within the scope of the respective session.

### Composition Graph

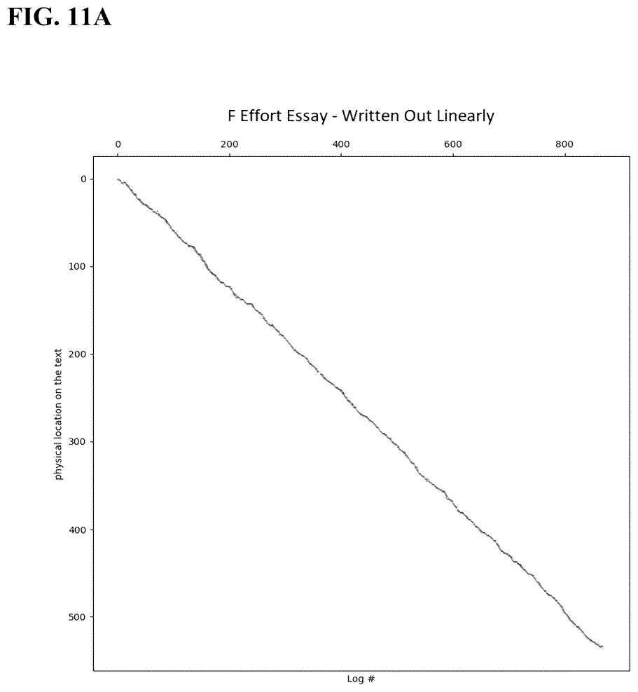

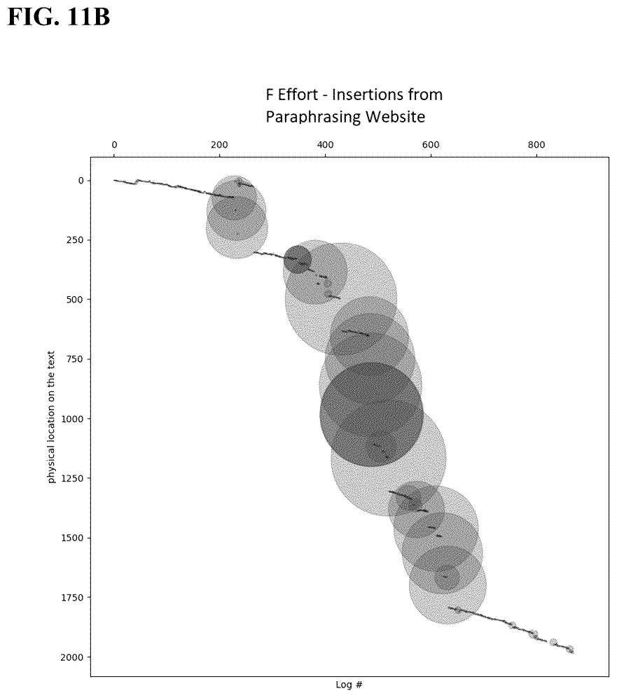

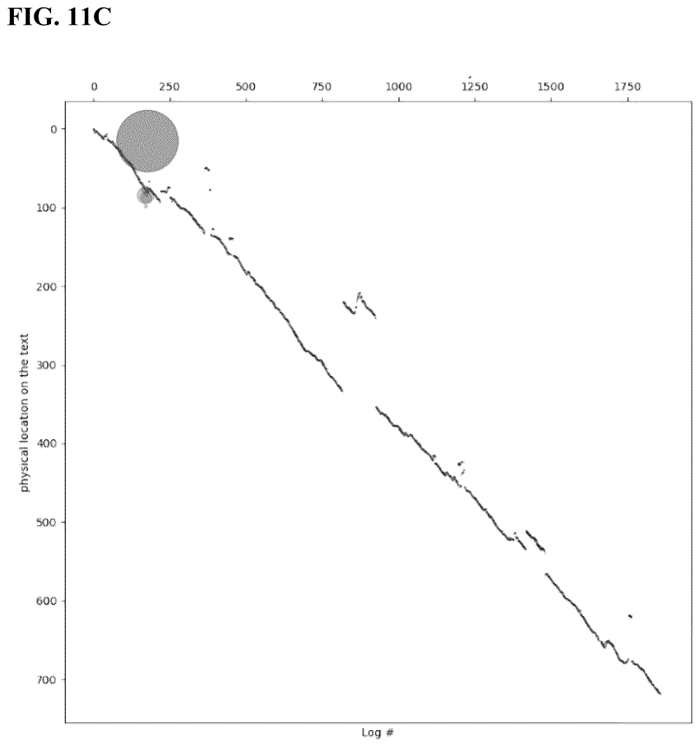

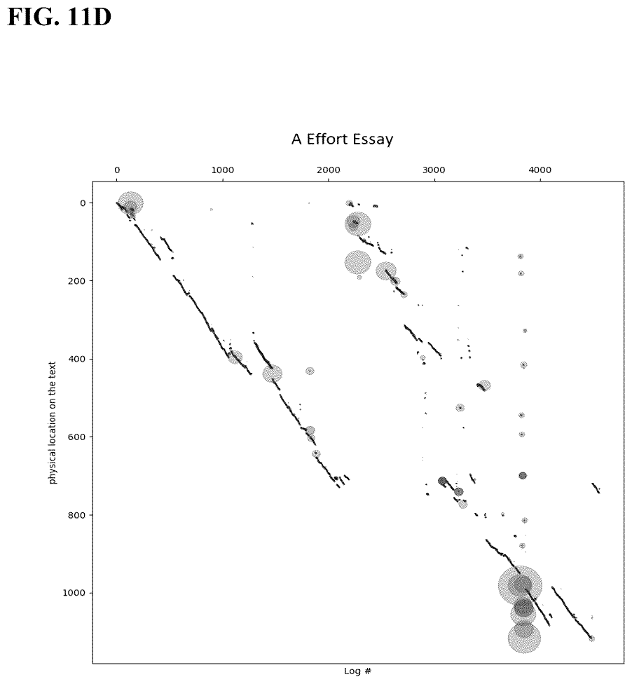

Speaking in more detail about the composition graph aspect of the system of the present invention, the composition graph is designed to visually represent the editing history and effort expended on a document. The composition graph, as shown in FIG. 8, as well as the samples of FIG. 11A through 11D, is structured around two primary axes: the X-axis (horizontal) and the Y-axis (vertical). Each axis serves a distinct purpose in depicting the dynamics of the writing process.

The X-axis represents the authoring timeline, illustrating the temporal aspect of the writing process, and chronologically tracks the progression of the writing session from its inception to completion. This axis enables observers to visualize the duration spent on the document, marking periods of intense activity, pauses, and revisions. By examining the distribution and density of activity along the X-axis, instructors can gauge the consistency of effort over time, identify patterns of writing and editing, and detect periods of inactivity that might suggest pauses for reflection or possible disengagement.

The Y-axis represents the progression of the document, often depicted in terms of word count or another metric indicative of document growth. This axis measures the depth of the writing effort, tracking changes in the document's length or structure as the writing evolves. It can show increments through additions (e.g., text insertions) and decrements through deletions, providing a sense of the document's expansion and refinement over time. The Y-axis offers insights into the extent of revision and editing activities. Fluctuations along this axis highlight areas of significant reworking or expansion, helping to identify which sections of the document received more attention and effort.

The intersection of activities plotted against these axes presents a comprehensive writing process overview. For instance:
a) Continuous Lines vs. Discrete Dots: A continuous line ascending steadily along the X-axis with minimal fluctuations on the Y-axis might indicate a straightforward writing process with few revisions. In contrast, a graph marked by significant vertical movements or discrete dots suggests a more iterative process characterized by extensive editing and revising.
b) Spikes and Gaps: Sudden spikes in the Y-axis can signal large insertions or deletions, possibly indicating substantial revisions or the incorporation of pre-written text. Gaps along the X-axis might denote periods of inactivity, reflective of pauses in the writing process.

FIGS. 11A through 11D are provided to allow a demonstration of the dual axis composition graph—referring to each for example:
a) FIG. 11A: If a student types out language written by AI (or another source) or writes an assignment with minimal effort or editing, it will appear in the graph as a continuous diagonal line from the upper left to the bottom right. Poor effort.
b) FIG. 11B: Language pasted into the assignment is represented as green or blue circles in the graph—the larger the insertion, the larger the circle. Red circles represent deleted language. In this assignment, the student wrote the introduction and the conclusion and copied the body paragraphs from an AI paraphrasing website with minimal editing. Poor effort.
c) FIG. 11C: On a graph for a medium-effort essay, the primary drafting lines will likely appear less fragmented than a high-effort essay but more fragmented and ‘wobbly’ than a low-effort essay.
d) FIG. 11D: The graph for a high-effort essay will likely appear more fragmented and more ‘archipelagic.’ Insertion circles, if present, will likely be smaller. A high-effort/high-revision essay will likely have a significant amount of editing in the upper right region of the graph.

### Evaluation Software Component

The evaluation software component 2 plays a crucial role in executing the methodologies and processes outlined in the present invention. The evaluation software component 2 is designed to operate seamlessly within a server environment (1), utilizing a processor (8) and memory (9) to manage and analyze data pertinent to the writing evaluation process. It is architected to interface effectively with both the work database (6) and the activity database (7), ensuring a fluid data exchange and analysis. It comprises several vital modules, including an Authoring Module, an Evaluation Module, and a Visualization Module, each dedicated to specific aspects of the writing analytics process.
A) Authoring Module: This module is responsible for facilitating the authoring sessions and managing the real-time capture of time-coded text snapshots 22 during the writing process. It incorporates algorithms designed to authenticate user sessions, create or access work records 10 in the work database 6, and serve an intuitive authoring interface to the users' devices 5;
B) Evaluation Module: This module engages during the evaluation sessions, employing sophisticated algorithms to compare time-adjacent groups of text snapshots 22. Utilizing detection parameters stored within the activity database 7, it identifies specific authoring activities, generating a dataset that reflects the effort and revision history of the document and
C) Visualization module—generates graphical representations of the writing process, including the composition graph and other interface components. This module translates complex data sets into intuitive visual formats, facilitating the instructors' assessment of writing effort and process.

The evaluation software component 2 is engineered for compatibility with various deployment environments, supporting both cloud-based and local network implementations. Its design accommodates integration with existing word processing and text editing platforms, either directly through web-based interfaces or indirectly through plug-ins or API connections, ensuring flexibility and ease of use for end-users.

The evaluation software component 2 provides a comprehensive suite of tools for monitoring, analyzing, and evaluating the writing process. This software identifies low-effort and high-effort writing patterns, supports the detection of AI-generated text, and facilitates the in-depth analysis of student writing processes. It represents a significant advancement in writing analytics, offering objective measures of student effort and engagement in a manner previously unattainable with traditional evaluation methods.

Although the present technology has been described in detail for illustration based on what is currently considered to be the most practical and preferred implementations, it is to be understood that such detail is solely for that purpose and that the technology is not limited to the disclosed implementations, but, on the contrary, is intended to cover modifications and equivalent arrangements that are within the spirit and scope of the appended claims. For example, it is to be understood that the present technology contemplates that, to the extent possible, one or more features of any implementation can be combined with one or more features of any other implementation.

In addition, it will be apparent to those of skill in the art that the present invention can be optimized for use in a wide range of conditions and application by routine modification. It will also be evident to those of skill in the art that there are various ways and designs to produce the apparatus and methods of the present invention. The illustrated embodiments are, therefore, not intended to limit the scope of the invention but to provide examples of the apparatus and method to enable those of skill in the art to appreciate the inventive concept.

1. A method of facilitating the evaluation of expended effort and revision in written works, said method using a system comprising:
a. a server comprising:
1. a processor and memory and at least one network interface capable of communication with client devices of authors and evaluators;
2. a work database comprising work records each corresponding to a written work created by at least one author in at least one authoring session comprising at least:
1. authentication particulars of each author of the work and each assigned evaluator;
2. for each authoring session, which total number of authoring sessions make up the authoring timeline, a plurality of periodically captured time-coded text snapshots of the work;
3. an activity database comprising activity records each corresponding to an authoring activity which can be performed in respect of a work and comprising at least:
1. detection parameters which can be used to identify the occurrence of the corresponding authoring activity between compared time-adjacent text snapshots; and
2. interface rendering information for use in the generation of a composition dashboard; and
4. an evaluation software component operating in conjunction with a word-processing software for facilitation of the steps of the method;
said method comprising, using the system:
a. upon receiving an authoring request from an author device at the server, commencing an authoring session by:
i. authenticating the requesting author device with the server;
ii. creating or accessing a selected work record corresponding to the work to be authored;
iii. serving an authoring interface to a human interface of the authenticated author device and facilitating related authoring and editing activity of the corresponding work;
iv. periodically capturing time-coded text snapshots of the work throughout the authoring session and storing same in association with the selected work record;
b. upon receiving an evaluation session request from an evaluator device at the server, commencing an evaluation session by:
i. authenticating the requesting evaluator device with the server in respect of a selected work record and its corresponding work;
ii. in respect of each time-adjacent pair of text snapshots stored in association with the selected work record, for each applicable activity record comparing the time-adjacent pair of text snapshots using the associated detection fingerprint to detect any occurrence of the corresponding authoring activity, any detected occurrence of the authoring activity being a time-coded authoring activity;
iii. generating and serving for human interface display to the evaluator device a graphical composition dashboard interface comprising at least a two-axis composition graph displaying:
i. a first axis defining the authoring timeline from its inception point to the point of capture of the selected version;
ii. a second axis representing the word length of the selected version of the work along which a particular time-coded authoring activity can be shown; and
iii. a plot point at the appropriate X-Y position on the evaluation graph corresponding to each detected time-coded authoring activity, the appearance of said plot point corresponding to the interface rendering information from the corresponding activity record.

2. The method of claim 1 wherein the human interface of the evaluator device in an evaluator session permits the evaluator to select a particular time point on the authoring timeline and the selected version of the work used is the captured time coded text most closely corresponding to the selected time point on the authoring timeline.

3. The method of claim 1 wherein activities encompassed within the activity database which can be detected and measured by the system are selected from the list of:
a. the size and time involved in inserting particular volumes of text;
b. the size or quantity of text deletions;
c. specific types of text edits such as punctuation changes, replacement of words, additions of words, addition of spaces, adding direct quotes, adding in-text citations;
d. the length of time associated with the creation of a particular block of text within the work;
e. insertions of particular grammatical structures;

4. The method of claim 1 wherein the selected version of the work used in the generation of a composition dashboard is:
a. the final time-coded text snapshot of the work; or
b. a particular selected time-coded text snapshot selected at the evaluator device through the user interface.

5. The method of claim 1 wherein:
a. activity records further comprise activity scoring data for use in the calculation of an evaluation score for the work; and
b. an evaluation session further comprises generating an evaluation score for the work and displaying same on the dashboard.

6. The method of claim 1 wherein the human interface display of the graphical composition dashboard permits the evaluator to select a particular plot point, and will adjust the displayed text snapshot of the work to show the time-coded text snapshot most closely corresponding to the particular plot point.

7. The method of claim 1 wherein the word processing software is:
a. hosted on the server of the system and the evaluation software component comprises an integrated software plugin hosted on the same server; or
b. separately hosted outside the system, with the evaluation software component integrated therewith across a computer network connection.

8. The method of claim 1 wherein the selected version used in generating the composition dashboard is:
a. the newest stored time-coded text snapshot of the work; or
b. a selected stored time-coded text snapshot of the work, selected by the user interface.

9. A system for facilitating a method of evaluation of expended effort and revision in written works comprising:
a. a server comprising:
1. a processor and memory and at least one network interface capable of communication with client devices of authors and evaluators;
b. a work database comprising work records each corresponding to a written work created by at least one author in at least one authoring session comprising at least:
1. authentication particulars of each author of the work and each assigned evaluator;
2. for each authoring session, which total number of authoring sessions make up the authoring timeline, a plurality of periodically captured time-coded text snapshots of the work;
c. an activity database comprising activity records each corresponding to an authoring activity which can be performed in respect of a work and comprising at least:
1. detection parameters which can be used to identify the occurrence of the corresponding authoring activity between compared time-adjacent text snapshots; and
2. interface rendering information for use in the generation of a composition dashboard;
d. an operative connection to a word processing software capable of facilitating authoring sessions with author devices; and
e. an evaluation software component operating in conjunction with the connected word processing software for facilitation of steps of the method of evaluation;
wherein the system operated by the evaluation software component will:
a. upon receiving an authoring request from an author device at the server, commence an authoring session by:
i. authenticating the requesting author device with the server;
ii. creating or accessing a selected work record corresponding to the work to be authored;
iii. serving an authoring interface to a human interface of the authenticated author device and facilitating related authoring and editing activity of the corresponding work;
iv. periodically capturing time-coded text snapshots of the work throughout the authoring session and storing same in association with the selected work record;
c. upon receiving an evaluation session request from an evaluator device at the server, commence an evaluation session by:
iv. authenticating the requesting evaluator device with the server in respect of a selected work record and its corresponding work;
v. in respect of each time-adjacent pair of text snapshots stored in association with the selected work record, for each applicable activity record comparing the time-adjacent pair of text snapshots using the associated detection fingerprint to detect any occurrence of the corresponding authoring activity, any detected occurrence of the authoring activity being a time-coded authoring activity;
vi. generating and serving for human interface display to the evaluator device at least a graphical composition dashboard interface comprising a two-axis composition graph displaying:
i. a first axis defining the authoring timeline from its inception point to the point of capture of the selected version;
ii. a second axis representing the word length of the selected version of the work along which a particular time-coded authoring activity can be shown; and
iii. a plot point at the appropriate X-Y position on the evaluation graph corresponding to each detected time-coded authoring activity, the appearance of said plot point corresponding to the interface rendering information from the corresponding activity record.

10. The system of claim 9 wherein the human interface of the evaluator device in an evaluator session permits the evaluator to select a particular time point on the authoring timeline and the selected version of the work used is the captured time coded text most closely corresponding to the selected time point on the authoring timeline.

11. The system of claim 9 wherein activities encompassed within the activity database which can be detected and measured by the system are selected from the list of:
a. the size and time involved in inserting particular volumes of text;
b. the size or quantity of text deletions;
c. specific types of text edits such as punctuation changes, replacement of words, additions of words, addition of spaces, adding direct quotes, adding in-text citations;
d. the length of time associated with the creation of a particular block of text within the work; and
e. insertions of particular grammatical structures.

12. The system of claim 9 wherein the selected version of the work used in the generation of a composition dashboard is:
a. the final time-coded text snapshot of the work; or
b. a particular selected time-coded text snapshot selected at the evaluator device through the user interface.

13. The system of claim 9 wherein:
a. activity records further comprise activity scoring data for use in the calculation of an evaluation score for the work; and
b. an evaluation session further comprises generating an evaluation score for the work and displaying same on the dashboard.

14. The system of claim 9 wherein the human interface display of the graphical composition dashboard permits the evaluator to select a particular plot point, and will adjust the displayed text snapshot of the work to show the time-coded text snapshot most closely corresponding to the particular plot point.

15. The system of claim 9 wherein the word processing software is:
a. hosted on the server of the system and the evaluation software component comprises an integrated software plugin hosted on the same server; or
b. separately hosted outside the system, with the evaluation software component integrated therewith across a computer network connection.

16. The system of claim 9 wherein the selected version used in generating the composition dashboard is:
a. the newest stored time-coded text snapshot of the work; or
b. a selected stored time-coded text snapshot of the work, selected by the user interface.
